(19) United States
(12) Patent Application Publication
(10) Pub. No.: US 2013/0067394 A1
(43) Pub. Date: Mar. 14, 2013

(54) POINTER INVOCABLE NAVIGATIONAL USER INTERFACE

(71) Applicants: Jennifer Nan, Seattle, WA (US); Patrice L. Miner, Kirkland, WA (US); Jesse Clay Satterfield, Seattle, WA (US); Nils Sundelin, Bothell, WA (US); Bret Anderson, Kirkland, WA (US); Matthew I. Worley, Bellevue, WA (US); Chaitanya D. Sareen, Seattle, WA (US); Robert Jarrett, Seattle, WA (US); Tsz Yan Wong, Seattle, WA (US)

(72) Inventors: Jennifer Nan, Seattle, WA (US); Patrice L. Miner, Kirkland, WA (US); Jesse Clay Satterfield, Seattle, WA (US); Nils Sundelin, Bothell, WA (US); Bret Anderson, Kirkland, WA (US); Matthew I. Worley, Bellevue, WA (US); Chaitanya D. Sareen, Seattle, WA (US); Robert Jarrett, Seattle, WA (US); Tsz Yan Wong, Seattle, WA (US)

(73) Assignee: Microsoft Corporation, Redmond, WA (US)

(21) Appl. No.: 13/230,737

(22) Filed: Sep. 12, 2011

(51) Int. Cl. G06F 3/048

(52) U.S. Cl. 715/784

(57) ABSTRACT

Systems and methods for use with a pointer invocable navigational user interface are provided. The system may include a navigational module configured to provide a navigational user interface having a hidden invocation region positioned along a logical left edge of a display. Application program graphical user interfaces (GUIs) may be ordered in an application order. The navigational module may be configured to detect an invocation pointer input in the hidden invocation region. Upon detecting the invocation pointer input, the navigational module may be to configured display a visible GUI selector element of the navigational user interface including a preview of a most recently used application program GUI not currently in focus. While the preview is displayed, a focus switching input from the pointer device may be received. In response to the focus switching input, focus may be switched to the application program GUI for which the preview is displayed.

### BACKGROUND

In a computer system with a multi-window desktop environment, several application program windows may be open at the same time. The windows may be stacked upon each other, and the window on the top may have “focus.” The window with focus receives user inputs from a keyboard and mouse when the mouse is positioned within the window. The open application windows are often included in an application list In some operating systems, each window in the application list has a corresponding icon displayed in a taskbar, typically positioned at the bottom of the desktop. To use a program with a window in the application list that does not have focus, the user may click on a visible portion of the window, or, for example if the window is completely hidden, the user may click on an appropriate program icon in the taskbar. If the user is unsure about which program icon represents which program, the user may hover the mouse pointer over the program icon, and after a period of time, a pop up preview is displayed adjacent the task bar program icon, to provide the user with a visual clue as to the application window associated with the task bar program icon.

While the task bar does allow the user to change focus between windows in the application list, the task bar has several drawbacks. First, many users prefer to hide the task bar, to expose more desktop area. The hidden task bar minimizes to a visible one pixel line across the bottom of the screen. Touching the one pixel line with a mouse pointer causes the taskbar to “fly in” from the bottom of the desktop and be displayed. Waiting for the taskbar to fly in and be displayed can be a frustrating delay for some users. Further, the two-step process of first displaying a program icon in the task bar, and then displaying a preview of the application window after a predetermined hover time, further adds to the delay that users experience as they hunt for a desired program window. As another drawback, the task bar can become crowded when a large number of program windows are open, resulting in a multitude of program icons being displayed in the task bar. The delay associated with waiting for a preview to be displayed can be compounded as the user mouses over each of many program icons in a crowded task bar searching for a desired program window.

### SUMMARY

Systems to address the above issues, systems and methods for use with a pointer invocable navigational user interface are provided. The system may include a computing device including a processor, memory, and a display, the processor being configured to execute a navigational module. The navigational module may be configured to provide a navigational user interface having a hidden invocation region positioned along a logical left edge of the display in a multi-window desktop environment having a desktop and a plurality of application program graphical user interfaces. The application program graphical user interfaces may be ordered in an application order. The navigational module may also be configured to detect an invocation pointer input in the hidden invocation region, the invocation pointer input being received from a pointer device. Upon detecting the invocation pointer input in the hidden invocation region, the navigational module may be to configured display a visible GUI selector element of the navigational user interface including a preview of a most recently used application program graphical user interface not currently in focus. Further, while the preview is displayed, a focus switching input from the pointer device may be received. In response to the focus switching input, focus of the multi-window desktop environment may be switched to the application program graphical user interface for which the preview is displayed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of computerized system including a navigational user interface in a desktop environment.

FIG. 2 is a flow chart of one embodiment of a method for providing a pointer invocable navigational user interface.

FIG. 3 is an illustration of a visible GUI selector element being repositioned corresponding to a pointer input location.

FIG. 4 is an illustration of an example scroll and dismissal input in a desktop environment with a navigational user interface.

FIG. 5 is an illustration of an example drag and drop input in a desktop environment with a navigational user interface.

FIG. 6 is an illustration of an example context menu pointer input in a desktop environment with a navigational user interface.

FIG. 7 is an illustration of an example focus switching input in a desktop environment with a navigational user interface.

FIG. 8 is an example computerized system for performing the method of FIG. 2.

### DETAILED DESCRIPTION

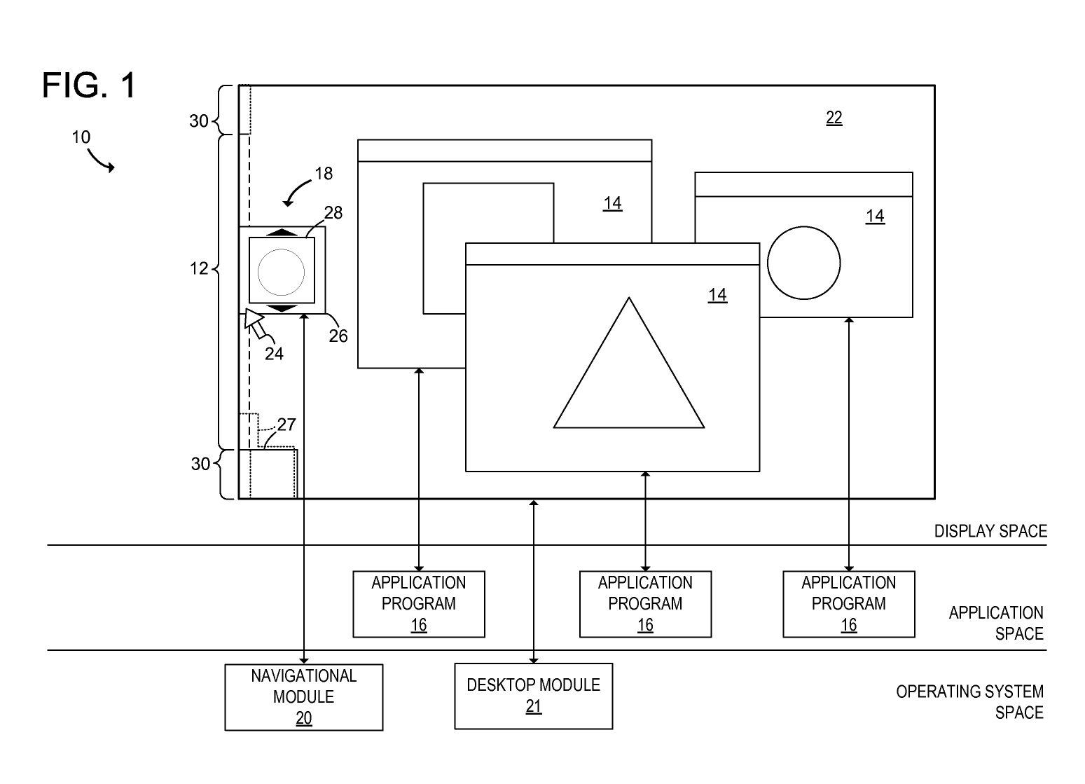

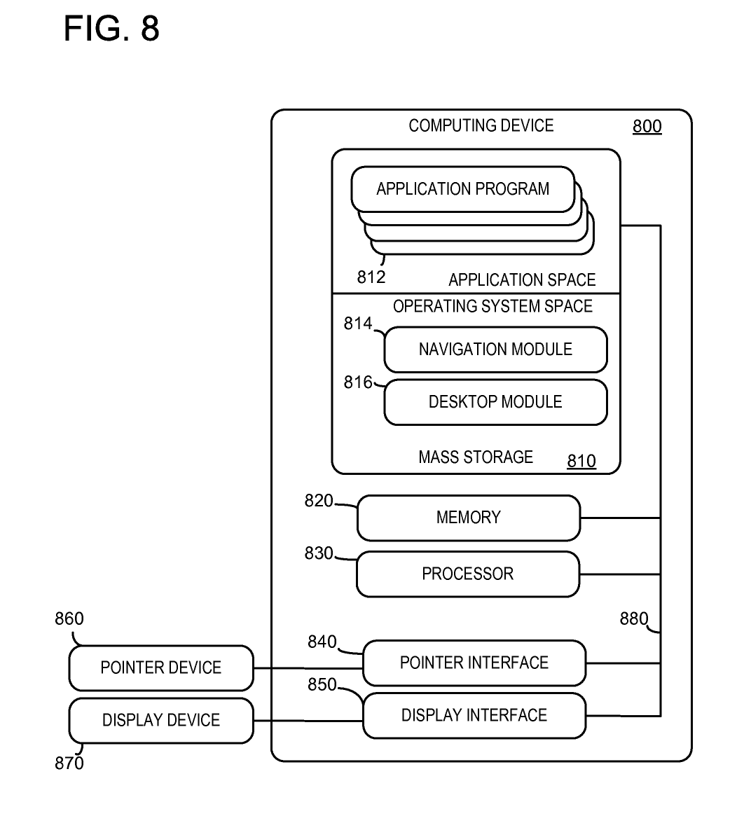

FIG. 1 illustrates an embodiment of a computerized system 10 for displaying a navigational user interface 18 in a multi-window desktop environment 22. The computerized system 10 may include application programs 16. The application programs 16 may be stored in mass storage and executed by a processor of the computerized system 10 using portions of memory as illustrated in FIG. 8, described below. During a typical session a user may wish to switch focus between various application programs 16. Such programs may include word processing programs, communication programs or photo editing programs, for example.

Each application program 16 may have a corresponding application program graphical user interface 14 of the multi-window desktop environment 22. The application program graphical user interfaces 14 may facilitate communication between a user and the application program 16 via a display and a pointer input device. For example, a user may point to and click on an icon in an application program graphical user interface 14 to execute a corresponding function of the application program 16.

Each application program 16 may have an application order. The application order may be represented in a suitable data structure for storing and sorting information about application programs 16 of the multi-window desktop environment 22. The application order may include information to identify which application programs 16 are currently running on computerized system 10, and which application programs 16 have most recently received user input via respective application program graphical user interfaces 14, for example.

Computerized system 10 may also be configured to execute a navigational module 20. The navigational module 20 may be utilized to perform a variety of functions, such as functions related to managing the focus of multi-window desktop environment 22. As used herein, an application program graphical user interface 14 is said to have focus if the window is displayed “on top” of other open application windows and user inputs are routed to a corresponding application program 16. Computerized system 10 may also be configured to execute a desktop module 21. The desktop module 21 may control a graphical desktop underlying the application program graphical user interface window having icons or other graphical elements representing files, folders, applications, etc.

The navigational module 20 may provide a navigational user interface 18 to receive inputs via a pointer input device and a display. The navigational user interface 18 may remain hidden unless invoked. When hidden, navigational user interface 18 may have no visible graphical user interface element. To facilitate invocation, the navigational user interface 18 may have a hidden invocation region 12 positioned along an edge of the display in the multi-window desktop environment 22. The invocation region may be positioned along a logical left edge of the display in some embodiments. It will be appreciated that the logical left edge is typically the left edge of the desktop in most user configurations, but in some reversed configurations the logical left and logical right sides of the desktop are reversed, and thus the logical left of the desktop may be along the right edge of the display. In some embodiments, no graphical elements indicate the existence of invocation region 12, and the invocation region itself may be invisible.

The navigational user interface 18 may be invocable by a pointer. For example, the navigational user interface 18 may be invoked by detecting an invocation pointer input in hidden invocation region 12. The pointer input may be received from a pointer device. The pointer device may be any suitable pointer device. In some embodiments, the pointer device is a mouse with a left click, a scroll, a right click, and a position user input. Other suitable pointer devices include touchpads, trackballs, or joysticks, for example.

The invocation pointer input may be detected when cursor 24 is controlled by a pointer device to be in invocation region 12. For example, a user may position cursor 24 in hidden invocation region 12 to invoke navigational user interface 18. Upon detecting the invocation pointer input in hidden invocation region 12, a visible GUI selector element 26 of the navigational user interface 18 may be displayed, thereby transitioning navigational user interface 18 from a hidden state to a displayed state.

In some embodiments, the GUI selector element 26 includes a preview 28 of a most recently used application program graphical user interface 14 not currently in focus. For example, if a user used a photo editing application program, and is subsequently using a web browsing application program, the preview 28 may be of the photo editing application program. However, any initial preview is compatible with the present disclosure, such as a preview of a most recently used application program graphical user interface (e.g. the web browsing application), a most often used application program graphical user interface, or a default application program graphical user interface, for example.

The GUI selector element may have a focus switch selector configured to, upon selection, switch focus according to an application order. For example, focus may be switched to a next application program graphical user interface not currently displayed. The focus switch selector may have a graphical indication of the next application program graphical user interface. For example, the graphical indication may include a preview of the next application program graphical user interface. Icons, text labels, or other graphical indicators may be used without departing from the scope of this disclosure. In some embodiments, the GUI selector element includes a graphical indicator of a single application.

In some embodiments, the visible GUI selector element 26 is displayed upon passage of a threshold period of time after detecting the invocation pointer input in invocation region 12. In this way, unwanted or unnecessary display of the GUI selector element 26 may be avoided, such as when a user briefly moves the cursor in and out of hidden invocation region 12. However, in some embodiments, user inputs may be sent to navigational module 20 before visible GUI selector element 26 is displayed. For example, a user may send inputs to the navigational module 20 while cursor 24 is in invocation region 12 prior to display of GUI selector element 26.

Once the navigational user interface 18 is invoked and the GUI selector element 26 is displayed, focus switching inputs may be received by navigational module 20 from a pointer device. As a nonlimiting example, a user may position cursor 24 in invocation region 12 to place the navigational user interface in a displayed state, showing GUI selector element 28 with a preview 26 of an application program graphical user interface 14. While the navigational user interface is in the displayed state, the user may left click on a mouse to send a focus switching input to navigation module 20. Focus switching inputs are used herein to describe an input to be received at navigational module 20 for purposes of switching focus from one application program graphical user interface 14 to another. As such, in response to receiving the focus switching input at navigation module 20, focus of the multi-window desktop environment 22 may be switched to the application program graphical user interface 14 for which the preview 26 is displayed.

In some embodiments, upon detection of the invocation pointer input in a system portion of the hidden invocation region, a system menu 27 is displayed providing system command options. For example, if a user is using a full screen application, commands may still be sent to the system by invoking such a system menu. The system portion of the hidden invocation region may be a square box of pixels in the lower left hand corner of a display, in addition to an L-shaped box of pixels at the same location.

The navigational user interface 18 may further include a dismissal region. The dismissal region may be used to return the navigational user interface 18 to a hidden state. For example, upon detection of a dismissal pointer input received from the pointer device in the dismissal region, navigational user interface 18 may be placed in a hidden state in which no visible element of the navigational user interface 18 is displayed. A user may send a dismissal pointer input by placing cursor 24 in a dismissal region, for example. Any suitable dismissal region may be utilized without departing from the scope of this disclosure.

In some embodiments, the dismissal region includes space on the display outside of the invocation region. As such, a user may return navigational user interface 18 to a hidden state by moving cursor 24 outside of invocation region 12. To make such an operation user friendly, invocation region 12 may be a column of single pixels, not including pixels proximate corner regions 30 of the display.

In some embodiments, the dismissal region includes space on the display outside of the invocation region prior to receiving a focus switching input, and includes space on the display outside of the visible GUI selector element after receiving a focus switching input. In this way, the navigational module is easy to dismiss prior to a user engaging an input, but once a user has utilized the functionalities of navigation module 20, it may be easier to continue using such functionalities without accidentally placing navigational user interface 18 in a hidden state.

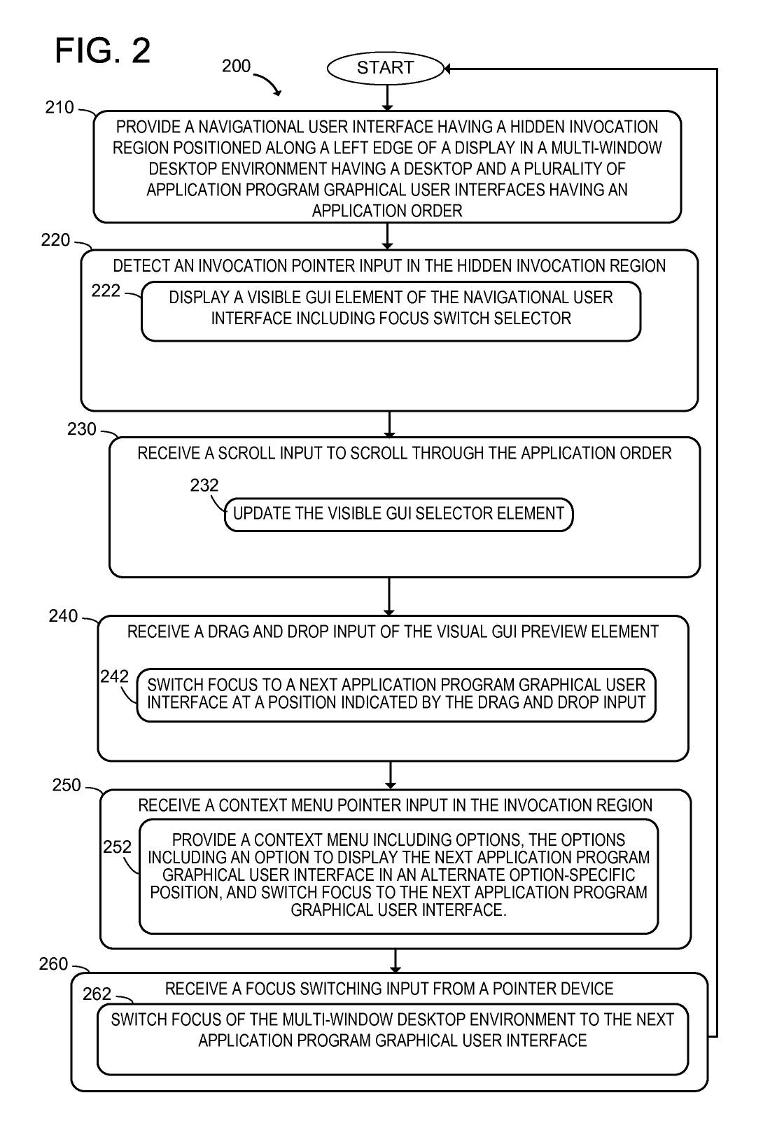

Turning to FIG. 2, FIG. 2 is a flow chart of one embodiment of a method 200 for providing a pointer invocable navigational user interface, such as the pointer navigational user interface described above with reference to FIG. 1. The method 200 may be performed by a navigational module executed by a processor of a computing device with portions of memory.

The method 200 may include, at 210, providing a navigational user interface. The navigational user interface may have a hidden invocation region, such as invocation region 12 described above. The navigational user interface may be provided in a multi-window desktop environment having a plurality of application program graphical interfaces ordered in an application order.

The navigational user interface may also include a dismissal region. The dismissal region may change based on inputs provided by a user. At any point along method 200, a user may provide a dismissal pointer input in a dismissal region to place the navigational user interface in a hidden state.

The method 200 may include, at 210, detecting an invocation pointer input in the hidden invocation region. For example, a pointer device controlled cursor placed in the hidden invocation region may cause the navigation module to display a visible GUI selector element of the navigational user interface. As described above, the preview may be of a most recently used application program graphical user interface not currently in focus.

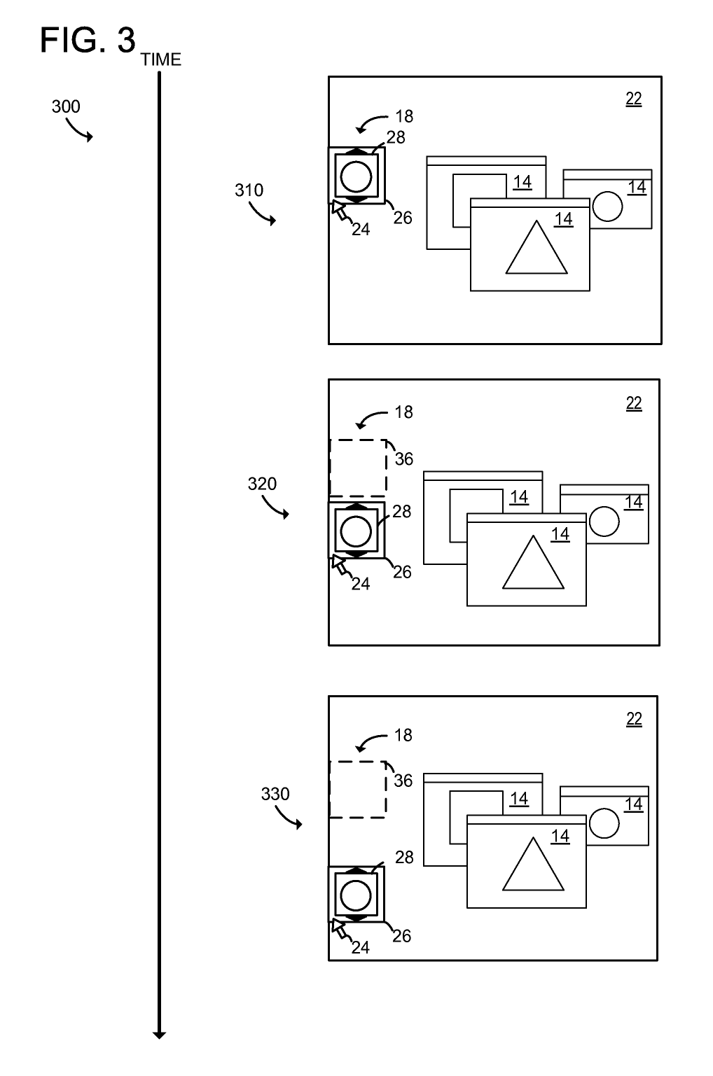

Briefly turning to FIG. 3, this figure shows a time series 300 of example navigational graphical user interfaces 18 displayed in response to receiving an invocation pointer input in a hidden invocation region. In the illustrated embodiment, an invocation pointer input is received at 310 in response to a cursor being placed in a hidden invocation region. In response, navigational user interface enters a displayed state and visible GUI selector element 26 is displayed.

In some embodiments, upon detection of a change in the vertical position of the invocation pointer input (cursor 24 in the illustrated embodiment), a visible GUI selector element is repositioned to be aligned with a new position of the invocation pointer input.

For example, at 320, cursor 24 has been vertically repositioned by a user, and in response, visible GUI selector element 26 is also repositioned from its original position 36. It is believed that this automatic repositioning allows for a more intuitive user experience. The visible GUI selector element 26 may continue to be repositioned as described upon further vertical movements of cursor 24, as shown at 330.

Turning back to FIG. 2, the method 200 may include, at 230, receiving a scroll input to scroll through the application order. A scroll input may be received via any suitable scroll input device, such as a scroll wheel on a mouse, for example. The scroll input device may be integrated with a pointer input device. Other scroll input devices may be utilized without departing from the scope of this disclosure. Upon receiving the scroll input to scroll through the application order, a visible GUI element may be updated at 232 to include a preview of for each of a plurality of successive application program graphical user interfaces in the application order. It should be appreciated that a scroll input could be received to scroll back and forth through the application order.

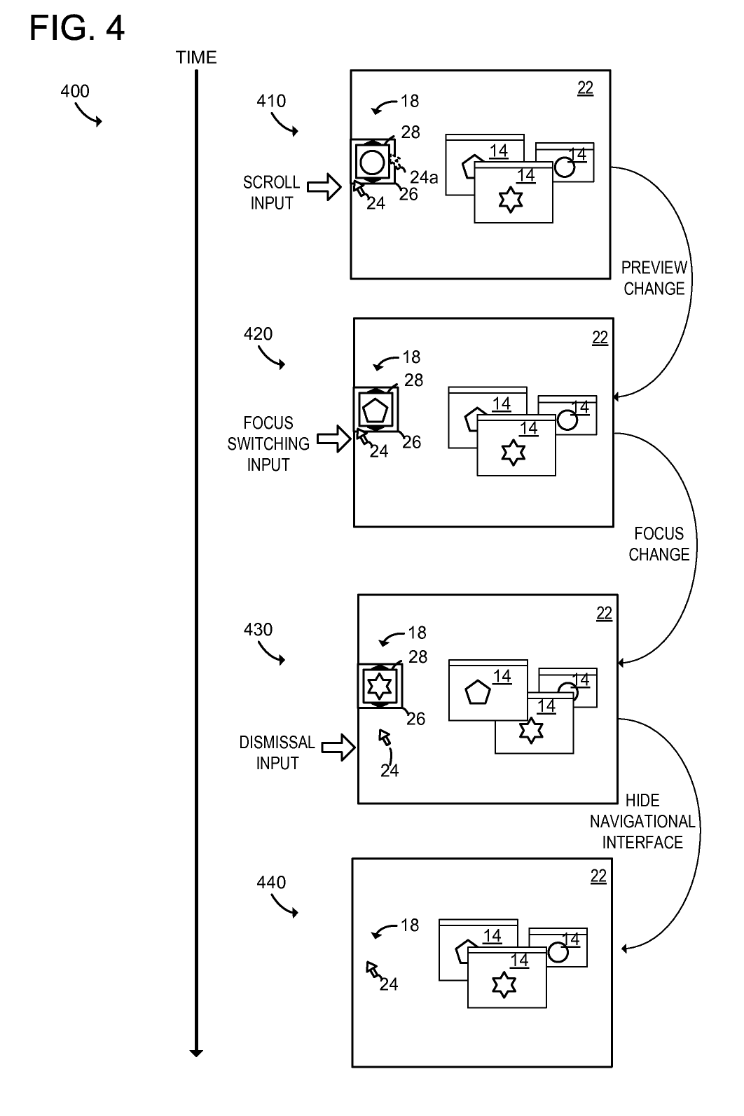

Turning briefly to FIG. 4, this figure illustrates a time series 400 of a sequence of example scroll inputs, a focus switching input, and a dismissal input. At 410, a cursor 24 is placed in an invisible invocation region. In response, a navigational graphical user interface 18 is displayed including a visible GUI selector element 26 and preview 28. It should be appreciated that some pixels of the visible GUI element may be outside of the hidden invocation region. As such, a small change in a horizontal position of the cursor (e.g. to position 24a) may cause the navigational graphical user interface 18 to be placed in a hidden state. Instead, if a user wishes to continue using navigational graphical user interface 18, a scroll input may be received to scroll through the application order.

Upon receiving the scroll input, preview 28 is updated as shown at 420 to display one of the application program graphical user interfaces 14 in the application order. In some embodiments, the scroll input does not cause focus to change. However, a subsequent focus switching input, such as a left click of a mouse button, may be received to switch focus of multi-window desktop environment 22 to the application program graphical user interface for which the preview is displayed.

At 430, a focus switching input has been received to bring focus to the application for which the preview 28 was presented at 420. A dismissal input may then be received at 430. The dismissal input may be sent from a user to a navigational module by moving cursor 24 into a dismissal region. Thus, the dismissal input may be a detected mouse over in the dismissal region. In the illustrated embodiment, the dismissal region is a region outside of the visible GUI element. In the illustrated hidden state, there are no visible graphical elements to indicate the navigational user interface 18, or the hidden invocation region.

Turning back to FIG. 2, the method 200 may include, at 240, receiving a drag and drop input (e.g. left clicking and dragging) of the visible GUI selector element. Responsive to receiving the drag and drop input, focus of the multi-window desktop environment may be switched, at 242. Focus may be switched to a next application program graphical user interface at a position indicated by the drag and drop input. For example, focus may be switched to the application program graphical user interface for which the preview is displayed in one of a snapped, filled, or fullscreen position corresponding to a respective snapped, filled, or fullscreen position.

A fullscreen position may be a position of an application program graphical user interface which utilizes desktop space without sharing space with another application. In some embodiments however, more than one application program graphical user interface occupies space on the desktop. For example, two application program graphical user interfaces may occupy space, with one utilizing significantly more space than the other. In one particular configuration, an application may use ⅔ of available desktop space, and the other may utilize the remaining ⅓. A filled position as used herein refers to a position of an application taking a majority of available space of a desktop, and a snapped position refers to a position of an application program graphical user interface taking the remaining smaller portion. However, it should be appreciated that virtually any position could be utilized in response to the drag and drop input without departing from the scope of this disclosure.

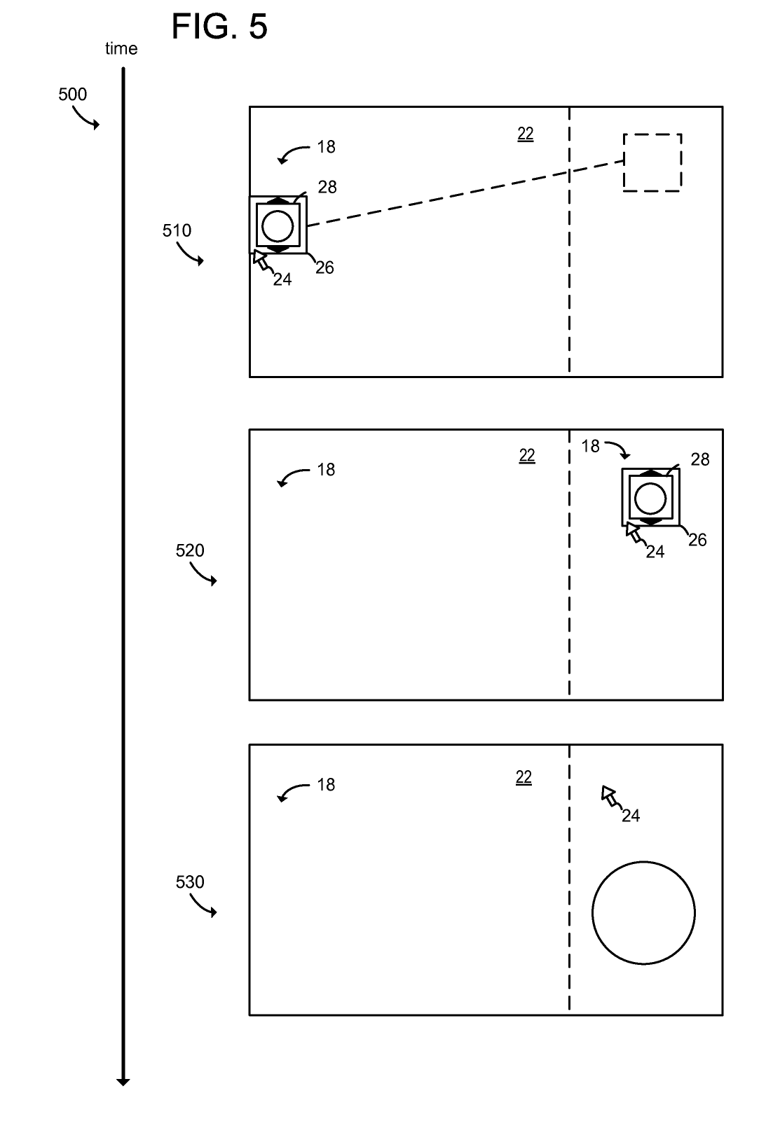

Turning briefly to FIG. 5, this figure illustrates a time series 500 of a drag and drop input of a visible GUI selector element 26. At 510, a cursor 24 is placed in an invisible invocation region. In response, a navigational graphical user interface 18 is displayed including a visible GUI selector element 26 and preview 28. At 520, the visible GUI element is dragged into a region corresponding to a snapped position. The drag may be initiated by holding a click input while repositioning cursor 24, for example. Upon receiving the initial click input, a dismissal region may be changed to include space on the display outside of the visible GUI element. At 520, while the cursor and visible GUI selector element are in a corresponding snapped location, a drop input may be received. The drop input may be sent by a user by releasing a previously held click input, for example. In response, an application program graphical user interface for which preview 28 was displayed may be placed in a snapped position, as shown at 530. Additionally, the visible GUI element may be removed, causing the cursor to be in a dismissal region. In response, the navigational interface 18 is placed in a hidden state.

Turning back to FIG. 2, the method may include, at 250, receiving a context menu pointer input in an invocation region. The context menu pointer input may be any suitable input, such as a right click of a mouse pointer input device. In response to receiving the context menu pointer input, the navigational graphical user interface may enter a context state at 252 in which a context menu is provided. The context menu may include a plurality of options selectable to display a next application program graphical user interface in an alternate option specific position. In other words, the context menu may provide features relating to a focus switch that aren't automatically utilized in a default focus switching input. Such options may include a snap option. For example, a user could select the snap option to cause the application program graphical user interface for which a preview is displayed to be in a snapped position. This causes, the application program graphical user interface to be be snapped to a respective snapped position.

In some embodiments, a fill option is provided. Selection of the fill option may cause the application program graphical user interface to be placed in a corresponding filled position. A fullscreen option may be similarly provided such that selection of the fullscreen option may cause the application program graphical user interface to be placed in a corresponding fullscreen position.

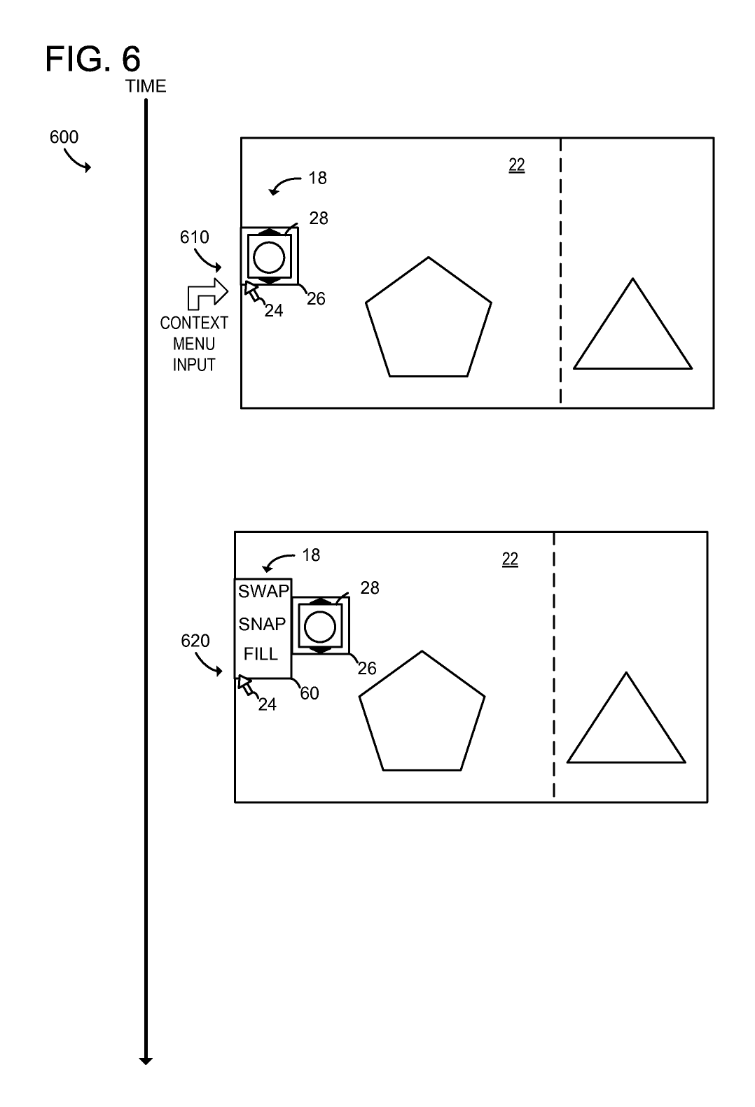

Turning briefly to FIG. 6, this figure illustrates a time series 600 of receiving a context menu pointer input in an invocation region. At 610, a cursor 24 is placed in an invisible invocation region. In response, a navigational graphical user interface 18 is displayed including a visible GUI selector element 26 and preview 28. A context menu pointer input is received, causing a context menu to be displayed at 620. The context menu may have selectable options to perform the operations described above.

Turning back to FIG. 2, the method 200 may include, at 260, receiving a focus switching input from a pointer device. In response, focus of a multi-window desktop environment may be switched to an application program graphical user interface for which the preview is displayed, as described above with reference to FIG. 1.

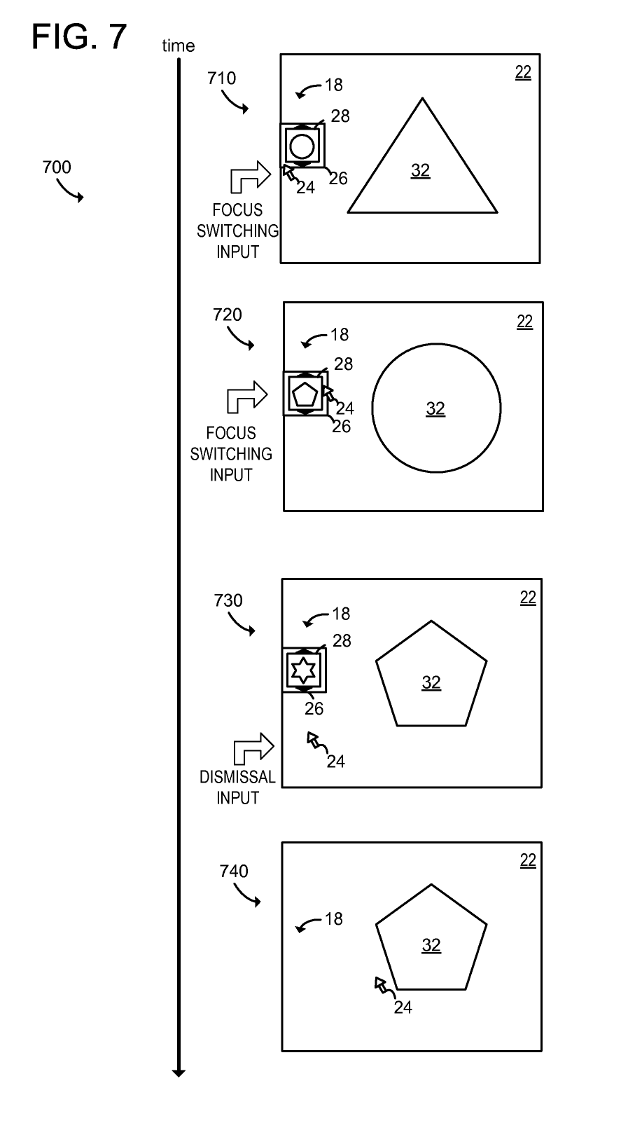

Turning briefly to FIG. 7, this figure illustrates a time series 700 of receiving a focus switching pointer input in an invocation region. At 710, a cursor 24 is placed in an invisible invocation region. In response, a navigational graphical user interface 18 is displayed including a visible GUI selector element 26 and preview 28.

A focus switching input may be received from the pointer device. Such a focus switching input may be a left click of a mouse pointer device, for example.

In response to receiving the focus switching input, focus may be switched to the application program graphical user interface for which the preview 28 is displayed. At 720 a multi-window desktop environment is shown just after receiving the focus switching input at 710. As illustrated, the preview 28 of an application program graphical user interface at 710 is shown in focus at 720. Additionally, at 720, the preview 28 is shown as updated to include a next application program graphical user interface in the application order.

Also in response to receiving the focus switching input, the dismissal region may be modified such that cursor 24 may be anywhere within visible GUI selector element 26 without causing the navigational graphical user interface 18 to be placed in a hidden state. As described above, this allows a user to be less precise with the positioning of cursor 24 without accidentally hiding navigational user interface 18. Another focus switching input may be received at 720, causing focus to switch, as shown at 730.

At 730, a dismissal input may be received. The dismissal input may result from a user moving cursor 24 outside of visible GUI selector element 26. The dismissal input may cause navigational user interface 18 to be placed in a hidden state, as shown at 740.

In some embodiments, the above described methods and processes may be tied to a computerized system including one or more computers. In particular, the methods and processes described herein may be implemented as an application program, computer service, computer API, computer library, and/or other computer program product.

FIG. 8 schematically shows a nonlimiting computing device 800 that may perform one or more of the above described methods and processes. Computerized system 800 is shown in simplified form. It is to be understood that virtually any computer architecture may be used without departing from the scope of this disclosure. In different embodiments, computerized system 800 may take the form of a mainframe computer, server computer, desktop computer, laptop computer, tablet computer, home entertainment computer, network computing device, mobile computing device, mobile communication device, gaming device, etc.

Computing device 800 may include mass storage 810. Mass storage 810 may have stored thereon a plurality of application programs 812, a navigation module 814, and a desktop module 816. These programs and modules may be similar or the same as those described with reference to FIG. 1. Computing device 800 may also include memory 820. The application programs 812, navigation module 814 and desktop module 816 may be loaded into portions of memory via bus 880 for execution by processor 830.

Pointer interface 840 may receive inputs from pointer device 860. Pointer device 860 may be virtually any device capable of discerning a pointer input from a user input. Pointer interface 840 may send inputs to portions of memory 820 to be executed by processor 830. Similarly, display interface 850 may output commands to display device 870. Such commands may include commands from the application programs 812, navigation module 814, or desktop module 816.

The terms “module,” “program,” and “engine” may be used to describe an aspect of computing system 800 that is implemented to perform one or more particular functions. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computerized system for displaying a pointer invocable navigational user interface, the system comprising a computing device including a processor, memory, and a display, the processor being configured to execute a navigational module, the navigational module being configured to:
provide a navigational user interface having a hidden invocation region positioned along an edge of the display in a multi-window desktop environment having a desktop and a plurality of application program graphical user interfaces, the application program graphical user interfaces having an application order;
detect an invocation pointer input in the hidden invocation region, the invocation pointer input being received from a pointer device;
upon detecting the invocation pointer input in the hidden invocation region, display a visible GUI selector element of the navigational user interface including a focus switch selector, configured to, upon selection, switch focus according to the application order to a next application program graphical user interface not currently displayed, the focus switch selector including a graphical indication of the next application program graphical user interface in the application order;
receive a scroll input to scroll through the application order and, in response, update the visible GUI selector element to include a graphical indication of the next application program graphical user interface for each of a plurality of successive application program graphical user interfaces in the application order;
while the visible GUI selector element is displayed, receive a focus switching input via the focus switch selector from the pointer device;
in response to the focus switching input, switch focus of the multi-window desktop environment to the next application program graphical user interface and display the next application program graphical user interface.

2. The computerized system of claim 1, where the navigational user interface has no visible graphical user interface element displayed in the hidden invocation region when the navigational user interface is in a hidden state.

3. The computerized system of claim 2, where the navigational user interface includes a dismissal region, and the navigational module is further configured to, upon detection of a dismissal pointer input received from the pointer device in the dismissal region, place the navigational user interface in the hidden state.

4. The computerized system of claim 3, where the dismissal region includes space on the display outside of the invocation region prior to receiving the focus switching input, and includes all space on the display outside of the visible GUI selector element after receiving the focus switching input, and where the invocation region is a column of single pixels, not including pixels proximate corner regions of the display.

5. The computerized system of claim 1, where the visible GUI selector element is displayed upon passage of a threshold period of time after detecting the invocation pointer input in the invocation region.

6. The computerized system of claim 1, where the graphical indication includes one of an icon, a preview of the next application program graphical user interface, or a text label, and the focus switch selector includes one of a button, a selectable preview, or a selectable icon.

7. The computerized system of claim 1, where, upon detection of a change in the vertical position of the invocation pointer input, the navigational module is further configured to reposition the visible GUI selector element to be aligned with a new position of the invocation pointer input.

8. The computerized system of claim 1, where the navigational module is further configured to, in response to receiving a drag and drop input of the visible GUI selector element, switch focus of the multi-window desktop environment to the next application program graphical user interface at a position indicated by the drag and drop input.

9. The computerized system of claim 1, where the navigational module is further configured to, in response to receiving a context menu pointer input in the invocation region, provide a context menu including options, the options including an option to display the next application program graphical user interface in a an alternate option-specific position, and switch focus to the next application program graphical user interface.

10. The computerized system of claim 1, where the navigational module is further configured to, upon detection of the invocation pointer input in a system portion of the hidden invocation region, display a system menu providing system command options, the system menu being separate from the visible GUI selector element.

11. A method executable by a computing device for displaying a pointer invocable navigational user interface, the method comprising, at a navigational module:
providing a navigational user interface having a hidden invocation region positioned along an edge of the display in a multi-window desktop environment having a desktop and a plurality of application program graphical user interfaces, the application program graphical user interfaces having an application order;
detecting an invocation pointer input in the hidden invocation region, the invocation pointer input being received from a pointer device;
upon detecting the invocation pointer input in the hidden invocation region, displaying a visible GUI selector element of the navigational user interface including a focus switch selector, configured to, upon selection, switch focus according to the application order to a next application program graphical user interface not currently displayed, the focus switch selector including a graphical indication of the next application program graphical user interface in the application order;
receiving a scroll input to scroll through the application order and, in response, updating the visible GUI selector element to include a graphical indication of the next application program graphical user interface for each of a plurality of successive application program graphical user interfaces in the application order;
receiving, while the visible GUI selector element is displayed, a focus switching input via the focus switch selector from the pointer device;
in response to the focus switching input, switching focus of the multi-window desktop environment to the next application program graphical user interface and displaying the next application program graphical user interface.

12. The method of claim 11, where the navigational user interface has no visible graphical user interface element displayed in the hidden invocation region when the navigational user interface is in a hidden state.

13. The method of claim 12, where the navigational user interface includes a dismissal region, and further comprising, upon detection of a dismissal pointer input received from the pointer device in the dismissal region, placing the navigational user interface in the hidden state.

14. The method of claim 13, where the dismissal region includes space on the display outside of the invocation region prior to receiving the focus switching input, and includes space on the display outside of the visible GUI selector element after receiving the focus switching input, and where the invocation region is a column of single pixels, not including pixels proximate corner regions of the display.

15. The method of claim 11, where the visible GUI selector element is displayed upon passage of a threshold period of time after detecting the invocation pointer input in the invocation region.

16. The method of claim 11, where the graphical indication includes one of an icon, a preview of the next application program graphical user interface, or a text label, and the focus switch selector includes one of a button, a selectable preview, or a selectable icon.

17. The method of claim 11, further comprising, in response to receiving a drag and drop input of the visible GUI selector element, switching focus of the multi-window desktop environment to the next application program graphical user interface at a position indicated by the drag and drop input.

18. The method of claim 11, further comprising, in response to receiving an context menu pointer input in the invocation region, providing a context menu including options, the options including an option to display the next application program graphical user interface in an alternate option-specific position, and switch focus to the next application program graphical user interface.

19. The method of claim 11, where the navigational module is further configured to, upon detection of the invocation pointer input in a system portion of the hidden invocation region, display a system menu providing system command options, the system menu being separate from the visible GUI selector element.

20. A method executable by a computing device for displaying a pointer invocable navigational user interface, the method comprising, at a navigational module:
providing a navigational user interface having a hidden invocation region positioned along a logical left edge of the display in a multi-window desktop environment having a desktop and a plurality of application program graphical user interfaces, the application program graphical user interfaces having an application order;
detecting an invocation pointer input in the hidden invocation region, the invocation pointer input being received from a pointer device;
upon detecting the invocation pointer input in the hidden invocation region, displaying a visible GUI selector element of the navigational user interface including a preview of a most recently used application program graphical user interface not currently in focus or displayed;
receiving a scroll input to scroll through the application order and in response, updating the visible GUI selector element to include a preview of an application program graphical user interface for each of a plurality of successive application program graphical user interfaces in the application order, until a preview of a selected one of the application program graphical user interfaces is displayed;
while the preview is displayed, receiving a focus switching input from the pointer device; and
in response to the focus switching input, switching focus of the multi-window desktop environment to the application program graphical user interface for which the preview is displayed.
